(19) United States
(12) Patent Application Publication
(10) Pub. No.: US 2013/0057909 A1
(43) Pub. Date: Mar. 7, 2013

(54) PRINTING APPARATUS CAPABLE OF COPING WITH DIFFERENT PRINT SETTINGS FROM THOSE THEREOF, METHOD OF CONTROLLING THE SAME, AND STORAGE MEDIUM

(71) Applicant: Kensuke Kawajiri, Yokohama-shi (JP)

(72) Inventor: Kensuke Kawajiri, Yokohama-shi (JP)

(73) Assignee: CANON KABUSHIKI KAISHA, Tokyo (JP)

(21) Appl. No.: 13/596,486

(22) Filed: Aug. 28, 2012

(30) Foreign Application Priority Data
Sep. 5, 2011 (JP) 2011-193132

(51) Int. Cl. G06K 15/02

(52) U.S. Cl. 358/1.15

(57) ABSTRACT

A printing apparatus incapable of changing print settings when executing printing, which is improved in user-friendliness when the print settings are different from the settings of the printing apparatus. The printing apparatus include an NVMEM storing setting information indicating predetermined respective settings for setting items for use in printing. A controller unit receives job information including image data to be printed, from a server. When the received job information includes setting information configured at the server, the setting information is caused to be temporarily stored in a RAM of the server. Some of the setting information configured at the server is stored in the NVMEM, and then the image data is printed according to the setting information.

### BACKGROUND OF THE INVENTION

1. Field of the Invention

The present invention relates to a printing apparatus capable of coping with different print settings from those of the printing apparatus when executing printing, a method of controlling the printing apparatus, and a storage medium.

2. Description of the Related Art

Conventionally, there has been widely known a technique in which settings of a printing apparatus or the like which prints out data are compared with information on a print job, and if the settings do not match the information, the printing apparatus or the like displays an error without executing printing.

In such a case, either the job is cancelled or the settings are changed to appropriate ones to thereby enable execution of printing. Further, as for the control of providing appropriate settings for the printing apparatus, there has been known e.g. a technique in which when using apparatuses of the same kind after replacing each other, settings of a self apparatus and settings of the other device are replaced by each other in advance (see e.g. Japanese Patent Laid-Open Publication No. 2006-39915).

In the above-mentioned technological background, some printing apparatuses are known which do not have a display panel but have only operating keys and LEDs. In general, such a printing apparatus can be given instructions via an application program running on a PC. This makes it possible to change settings for the above-mentioned printing apparatus via the application program running on the PC. However, it is impossible to change the settings using operating keys of the printing apparatus.

Therefore, in such a printing apparatus, in a case where a comparison between the settings of the printing apparatus with the information on the print job indicates a mismatch, even if a user is made aware of an error by LED display of the printing apparatus, he/she is incapable of changing the settings of the printing apparatus by the operating keys thereof.

For this reason, it has been a problem that the user has to return to the PC to change the settings via the application program running on the PC. This problem becomes more serious e.g. when the printing apparatus and the PC are installed at respective locations not close to each other.

As described above, according to the conventional technique, in a case where print settings are different from the settings of the printing apparatus when executing printing, the printing apparatus incapable of changing the settings has to have the settings changed by an apparatus capable of changing the settings.

Therefore, the printing apparatus which is incapable of changing print settings when they are different from the settings of the printing apparatus has a problem that it sometimes fails to be user-friendly enough.

### SUMMARY OF THE INVENTION

It is an object of the present invention to provide a printing apparatus incapable of changing print settings when executing printing, which is improved in user-friendliness when the print settings are different from the settings of the printing apparatus, a method of controlling the same, and a storage medium.

In a first aspect of the present invention, there is provided a printing apparatus including a storage unit that stores setting information indicating predetermined respective settings for setting items which are for use in printing, comprising a reception unit configured to receive job information including image data to be printed, from a host device, a hold unit configured to, in a case where the job information which is received by the reception unit includes setting information configured at the host device, temporarily hold the setting information stored in the storage unit, a storing unit configured to store the setting information configured at the host device in the storage unit, and a printing unit configured to print the image data according to the setting information stored by the storing unit.

In a second aspect of the present invention, there is provided a method of controlling a printing apparatus including a storage unit that stores setting information indicating predetermined respective settings for setting items which are for use in printing, comprising receiving job information including image data to be printed, from a host device, temporarily holding, in a case where the received job information includes setting information configured at the host device, the setting information stored in the storage unit, storing the setting information configured at the host device in the storage unit, and printing the image data according to the setting information stored by the storing.

In a third aspect of the present invention, there is provided a non-transitory computer-readable storage medium storing a computer-executable program for causing a computer to execute a method of controlling a printing apparatus including a storage unit that stores setting information indicating predetermined respective settings for setting items which are for use in printing, wherein the method comprises receiving job information including image data to be printed, from a host device, temporarily holding, in a case where the received job information includes setting information configured at the host device, the setting information stored in the storage unit, storing the setting information configured at the host device in the storage unit, and printing the image data according to the setting information stored by the storing.

According to the present invention, a printing apparatus incapable of changing print settings before executing printing is made capable of coping with print settings of a print job which are different from the settings of the printing apparatus, whereby the printing apparatus can be improved in user-friendliness.

Further features of the present invention will become apparent from the following description of exemplary embodiments with reference to the attached drawings.

### BRIEF DESCRIPTION OF THE DRAWINGS

FIG. 1 is a diagram showing a schematic configuration of a system including a printing apparatus according to an embodiment of the present invention.

FIG. 2 is a diagram showing the hardware configuration of both a PC and a server appearing in FIG. 1.

FIG. 3 is a diagram showing the hardware configuration of the printing apparatus appearing in FIG. 1.

FIG. 4 is an schematic view of part of a cross-section of the printing apparatus.

FIG. 5 is a diagram showing an example of a screen of a user interface application displayed on a display section appearing in FIG. 2.

FIG. 6 is a detailed diagram of a configuration dialog.

FIG. 7 is a diagram showing a management table of the printing apparatus in which settings set via the configuration dialog are stored.

FIG. 8 is a diagram showing an example of a screen of a printer driver displayed on the display section.

FIG. 9 is a diagram showing job information in a case where no additional setting information has been added.

FIG. 10 is a diagram showing a setting information addition dialog displayed on the display section.

FIG. 11 is a diagram showing print information in a case where additional setting information is added.

FIG. 12 is a flowchart of a print process executed by a CPU appearing in FIG. 2.

### DESCRIPTION OF THE EMBODIMENTS

The present invention will now be described in detail below with reference to the accompanying drawings showing an embodiment thereof.

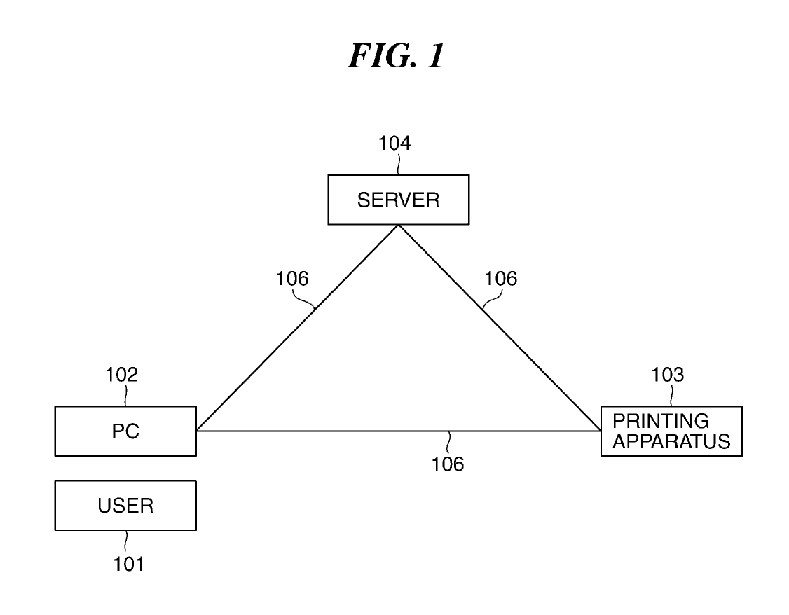

FIG. 1 is a diagram showing a schematic configuration of a system including a printing apparatus according to an embodiment of the present invention.

In FIG. 1, the printing apparatus, denoted by reference numeral 103, a PC (personal computer) (host device) 102, and a server 104 are connected by a LAN (local area network) 106. A user 101 can configure or instruct the printing apparatus 103 as desired, by operating a user interface application running on the PC 102. Note that the LAN 106 can be another kind of network.

The user 101 can send a job to the server 104 by operating a printer driver running on the PC 102. The printing apparatus 103 can issue a job transmission request to the server 104. Upon receipt of the job transmission request, the server 104 sends the job to the printing apparatus 103.

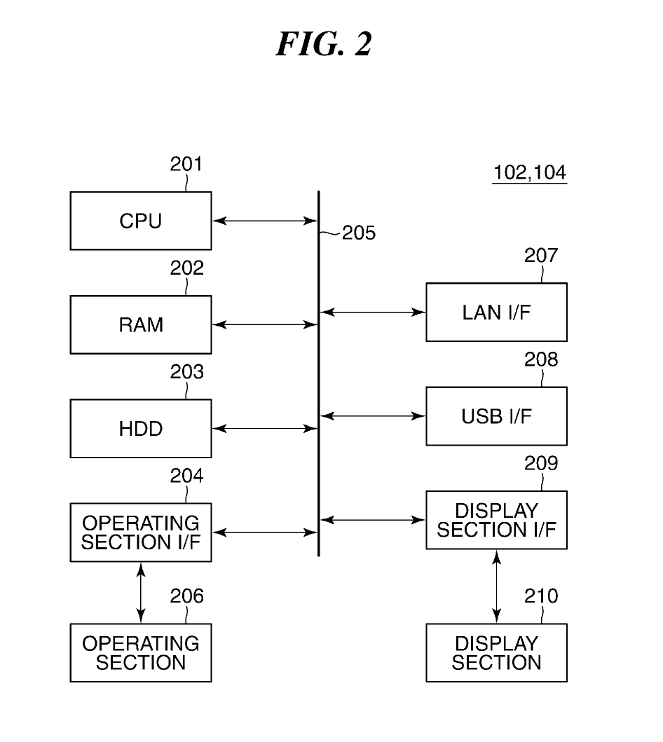

FIG. 2 is a diagram showing the hardware configuration of both the PC 102 and the server 104 shown in FIG. 1. The PC 102 and the server 104 have the same hardware configuration, and hence description of the hardware configuration is given by referring to the figure of single hardware configuration in which each corresponding components thereof are denoted by a same reference numeral.

In FIG. 2, a CPU 201 is a processor that controls the whole system of each of the PC 102 and the server 104. A RAM 202 is a system working memory for operation of the CPU 201, and is used as a program memory in which programs are loaded. A HDD 203 is a data storage area that stores various programs which are executed by the CPU 201, and image data.

An operating section interface 204 is an interface with an operating section 206, and receives an input signal from the operating section 206. Further, the operating section interface 204 plays a role of transmitting information which the user inputs from the operating section 206, to the CPU 201.

A display section interface 209 is an interface with a display section 210, and outputs an output signal to the display section 210 under the control of the CPU 201. A USB interface 208 is a functional unit for connecting to a USB device, and is used to retrieve a status of the USB device and return a status of the PC 102 (or the server 104) to the USB device, by USB (universal serial bus).

A LAN interface 207 is a functional unit for connecting to a LAN, and is used to retrieve a status of another device and to return a status of the PC 102 (or the server 104) thereto via the LAN. The CPU 201, the RAM 202, the HDD 203, the operating section interface 204, the LAN interface 207, the USB interface 208, and the display interface 209 are connected to each other via a system bus 205.

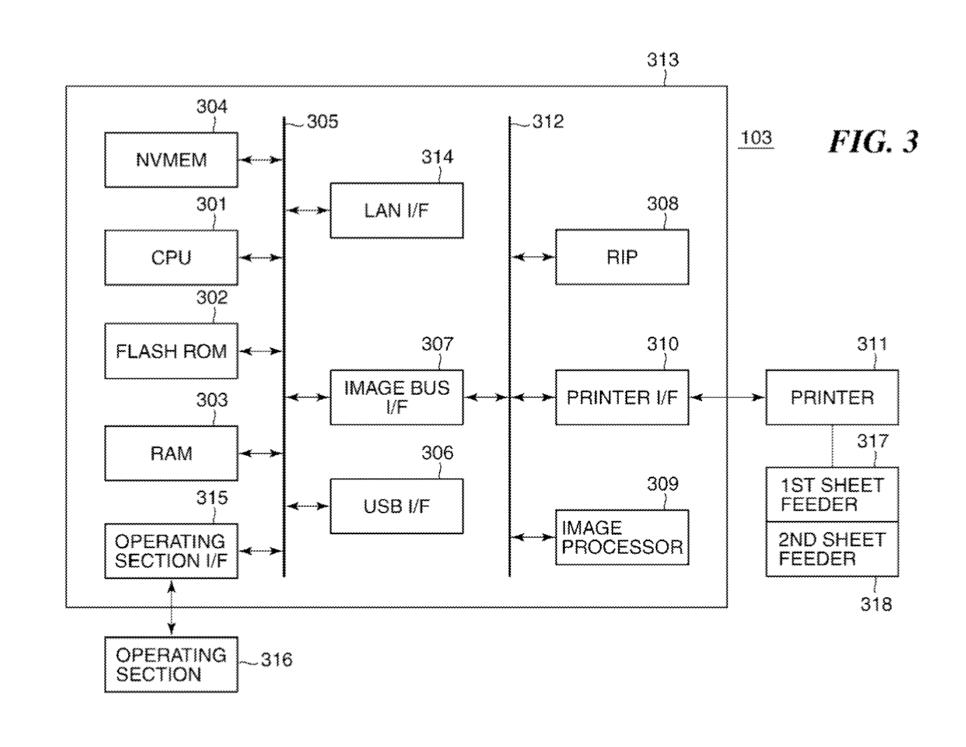

FIG. 3 is a diagram showing the hardware configuration of the printing apparatus 103 appearing in FIG. 1.

In FIG. 3, a controller unit 313 is connected to a printer 311 that serves as an image output device and thereby inputs and outputs image data and device information to and from the printer 311.

A CPU 301 is a processor that controls the whole system of the printing apparatus 103. A RAM 303 is a system working memory for operation of the CPU 301, and also serves as a program memory into which programs are loaded and as an image memory for temporarily storing image data. An NVMEM 304 is a nonvolatile memory, and records setting information and so forth.

An operating section 316 includes keys for operating the printing apparatus 103 and LEDs that indicate a status of the printing apparatus 103. An operating section interface 315 is an interface with the operating section 316, and transmits control information to the LEDs of the operating section 316. Further, the operating section interface 315 plays a role of transmitting information input by the user via the operating section 316 to the CPU 301.

A first sheet feeder 317 and a second sheet feeder 318 hold sheets, and feed sheets when the printer 311 executes printing.

A flash ROM 302 is a rewritable nonvolatile memory in which various control programs controlling the system are recorded. A USB interface 306 enables connection between the PC 102 and a USB device. A LAN interface 314 enables connection between the PC 102 and the LAN 106.

An image bus interface 307 is a bus bridge that connects between a system bus 305 and an image bus 312 that transfers image data at high speed, and converts data structure when data is transferred from one bus to the other or vice versa. The image bus 312 is implemented by a PCI bus or IEEE 1394.

On the image bus 312, the following devices are arranged. A RIP (raster image processor) 308 converts vector data, such as PDL code, to bitmap image. A printer interface 310 connects between the printer 311 and the controller unit 313, and performs conversion of image data between synchronous data and asynchronous data.

An image processor 309 subjects input image data to correction, manipulation, and editing, and subjects output print image data to correction, resolution conversion, and so forth. In addition thereto, the image processor 309 performs rotation of image data, and performs JPEG compression or expansion processing on multi-valued image data, and JBIG, MMR, MH, or the like compression or expansion processing on binary image data.

The printer 311 is a section that converts raster image data to an image on a sheet. The method is an electrophotographic method using a photosensitive drum or a photosensitive belt. A print operation is started by an instruction from the CPU 301.

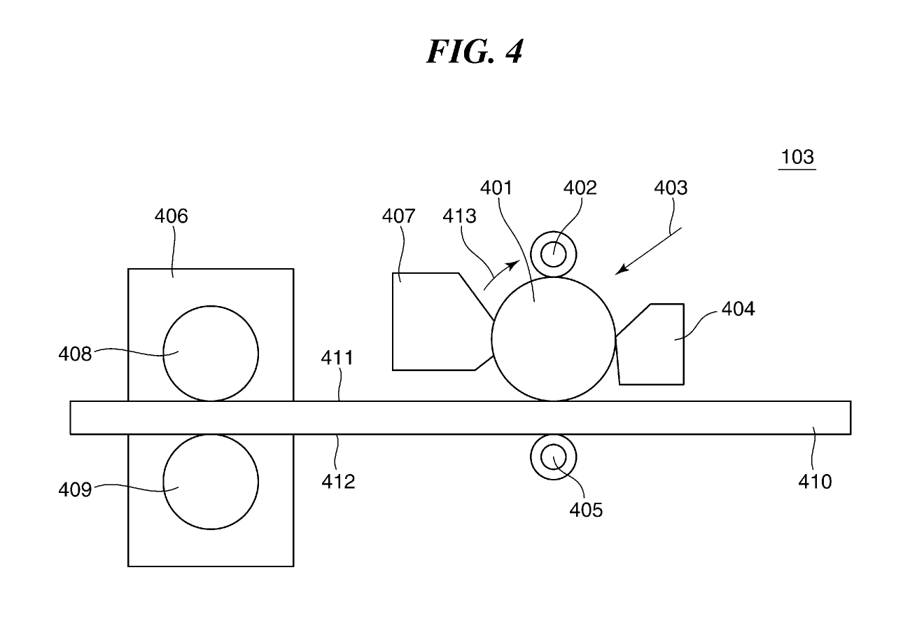

FIG. 4 is a schematic view of part of a cross-section of the printing apparatus 103.

A photosensitive drum 401 comprises a cylindrical substrate made of aluminum or nickel, and photosensitive material, such as OPC (organic photoconductor), amorphous Se, or amorphous Si, formed on the cylindrical substrate. The photosensitive drum 401 is driven for rotation in the direction of an arrow 413, and has a surface thereof uniformly electrostatically charged by a charge roller 402 as an electrical charge device.

Then, the photosensitive drum 401 is subjected to scanning exposure according to image information by a laser beam 403 under on-off control, whereby an electrostatic latent image is formed on the photosensitive drum 401. The electrostatic latent image is developed and visualized by a developing device 404. As a development method, there may be employed any of a jumping development method, a two-component development method, a FEED development method, etc., and a combination of image exposure and reversal development is often used.

A visualized unfixed toner image is transferred from the surface of the photosensitive drum 401 onto a surface 411 of a recording material 410 conveyed thereto in predetermined timing by a transfer roller 405 as a transfer device. No toner image is transferred onto a surface 412.

At this time, the recording material 410 is conveyed in a state sandwiched between the photosensitive drum 401 and the transfer roller 405 under predetermined pressure. The recording material 410 having the unfixed toner image is transferred is conveyed to a fixing device 406, where the image on the recording material 410 is fixed.

The fixing device 406 comprises a fixing roller 408 and a pressure roller 409. A residual toner remaining untransferred to the photosensitive drum 401 is removed from the surface of the photosensitive drum 401 by a cleaning device 407.

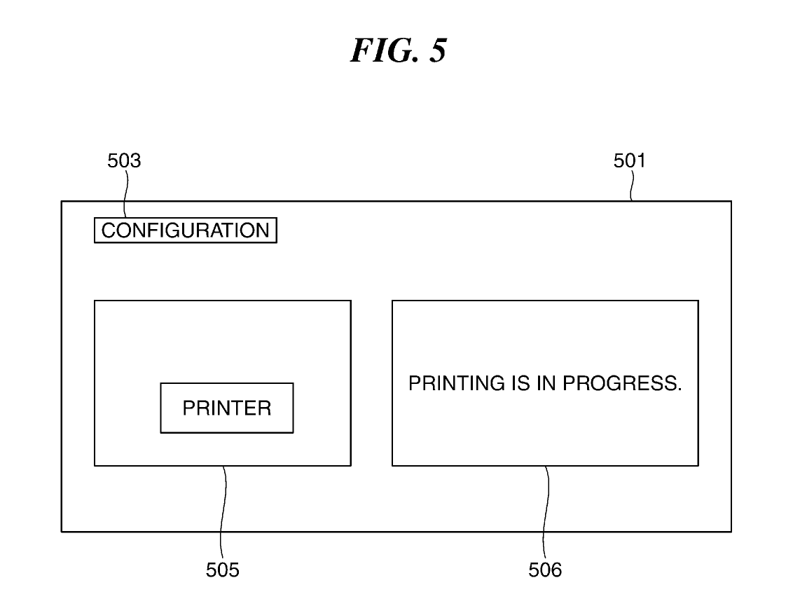

FIG. 5 is a diagram showing an example of a screen of a user interface application 501 displayed on the display section 210 appearing in FIG. 2. In FIG. 5, the user interface application 501 is represented by the screen displayed thereby.

Note that the screen illustrated in FIG. 5 by way of example is a screen via which the user can operate the printing apparatus 103 provided with no console panel.

The user interface application 501 is executed by the CPU 201 of the PC 102. The user interface application 501 is connected to the printing apparatus 103 through the LAN interface 207. When the user 101 installs the user interface application 501, the user interface application 501 is associated with the printing apparatus 103.

The user interface application 501 includes a device status display section 505. The device status display section 505 displays a screen indicative of the status of the printing apparatus 103 which is connected to the user interface application 501.

The user interface application 501 includes a device status explaining section 506. The device status explaining section 506 displays text indicative of the status of the printing apparatus 103 which is connected to the user interface application 501. In FIG. 5, the text “Printing is in progress.” is displayed.

The user interface application 501 includes a configuration button 503. When the user depresses the configuration button 503 using the operation section 206, a configuration dialog, described hereafter, is displayed.

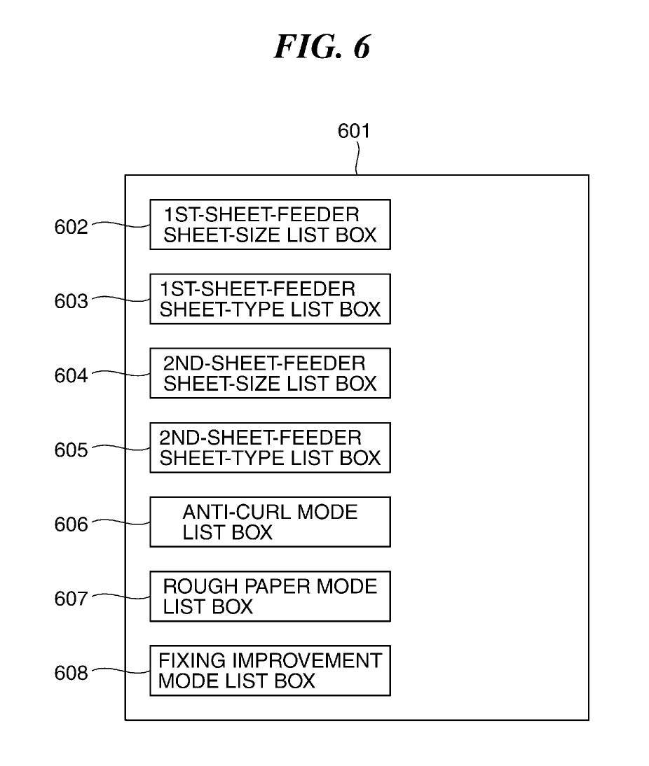

FIG. 6 is a detailed diagram of the configuration dialog, denoted by reference numeral 601.

Display of the configuration dialog 601 is executed by the CPU 201 of the PC 102. The user 101 operates the configuration dialog 601 by using the operating section 206, and can configure the settings of the printing apparatus 103 as desired.

By selecting an option from a first-sheet-feeder sheet-size list box 602, the user can designate the size of sheets set in the first the sheet feeder 317. Selectable options (sheet sizes) are A4, A3, B5, letter size, and so forth. A selected sheet size is notified to the printing apparatus 103 through the LAN interface 207, and is stored in the NVMEM 304.

By selecting an option from a first-sheet-feeder sheet-type list box 603, the user can designate the type of sheets set in the first the sheet feeder 317. Selectable options (sheet types) are plain paper, thick paper, thin paper, and so forth. A selected sheet type is notified to the printing apparatus 103 through the LAN interface 207, and is stored in the NVMEM 304.

By selecting an option from a second-sheet-feeder sheet-size list box 604, the user can designate the size of sheets set in the second sheet feeder 318. Selectable options (sheet sizes) are A4, A3, B5, letter size, and so forth. A selected sheet size is notified to the printing apparatus 103 through the LAN interface 207, and is stored in the NVMEM 304.

By selecting an option from a second-sheet-feeder sheet-type list box 605, the user can designate the type of sheets set in the second sheet feeder 318. Selectable options (sheet types) are plain paper, thick paper, thin paper, and so forth. A selected sheet type is notified to the printing apparatus 103 through the LAN interface 207, and is stored in the NVMEM 304.

By selecting an option from an anti-curl mode list box 606, it is possible to set the temperature of the fixing device 406 to a lower temperature. This makes it possible to prevent sheets from curling. Selectable options (operation mode values) are “not set”, “level 1”, and “level 2”. Level 2 sets the temperature of the fixing device 406 to a lowest temperature. A selected operation mode value is notified to the printing apparatus 103 through the LAN interface 207, and is stored in the NVMEM 304.

By selecting an option from a rough paper mode list box 607, it is possible to set the temperature of the fixing device 406 to a higher temperature. This makes it possible to prevent insufficient fixing of toner on the sheet. Selectable options (operation mode values) are “not set”, “level 1”, and “level 2”. Level 2 sets the temperature of the fixing device 406 to a highest temperature. A selected operation mode value is notified to the printing apparatus 103 through the LAN interface 207, and is stored in the NVMEM 304.

Note that if an operation mode value other than “not set” is selected in the anti-curl mode list box 606, a setting in the rough paper mode list box 607 is made invalid. Similarly, if an operation mode value other than “not set” is selected in the rough paper mode list box 607, a setting in the anti-curl mode list box 606 is made invalid.

By selecting an option from a fixing improvement mode list box 608, it is possible to set the amount of toner for an unfixed toner image visualized on the photosensitive drum 401 to a smaller value. This makes it possible to prevent degradation of an image when the toner is fixed on the sheet.

Selectable options (operation mode values) are “not set”, “level 1”, and “level 2”. Level 2 sets the amount of the toner to the smallest value. A selected operation mode value is notified to the printing apparatus 103 through the LAN interface 207, and is stored in the NVMEM 304.

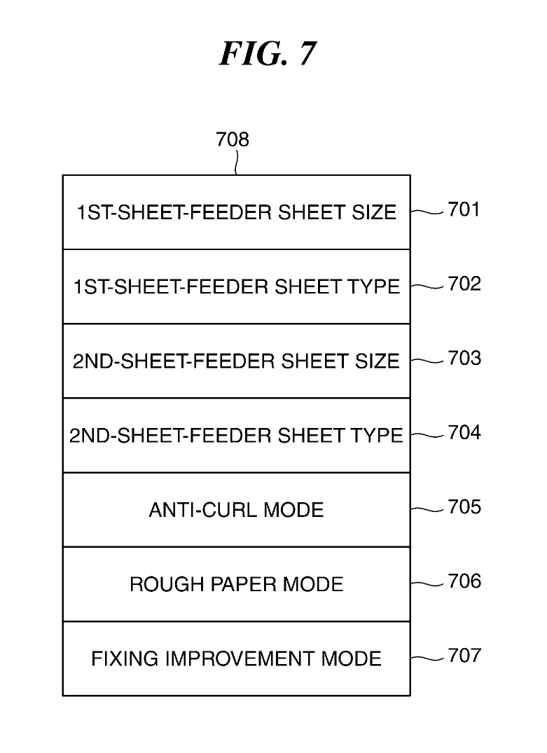

FIG. 7 is a diagram showing a management table 708 of the printing apparatus 103 in which settings set by the configuration dialog 601 are stored.

The management table 708 is stored in the NVMEM 304 and the settings therein are also stored in the RAM 202 of the server 104.

In a first-sheet-feeder sheet size 701, the size of sheets set in the first sheet feeder 317 is stored. Sheet sizes which can be recorded in this field are A4, A3, B5, letter size, and so forth. A default value is A4.

In a first-sheet-feeder sheet type 702, the type of sheets set in the first sheet feeder 317 is stored. Sheet types which can be recorded in this field are plain paper, thick paper, thin paper, and so forth. A default value is plain paper.

In a second-sheet-feeder sheet size 703, the size of sheets set in the second sheet feeder 318 is stored. Sheet sizes which can be recorded in this field are A4, A3, B5, letter size, and so forth. A default value is A4.

In a second-sheet-feeder sheet type 704, the type of sheets set in the second sheet feeder 318 is stored. Sheet types which can be recorded in this field are plain paper, thick paper, thin paper, and so forth. A default value is plain paper.

In an anti-curl mode 705, the operation mode value of the anti-curl mode of the printing apparatus 103 is stored. Operation mode values which can be recorded in this field are “not set”, “level 1”, and “level 2”. A default value is “not set”.

In a rough paper mode 706, the operation mode value of the rough paper mode of the printing apparatus 103 is stored. Operation mode values which can be recorded in this field are “not set”, “level 1”, and “level 2”. A default value is “not set”.

In a fixing improvement mode 707, the operation mode value of the fixing improvement mode of the printing apparatus 103 is stored. Values which can be recorded in this field are “not set”, “level 1”, and “level 2”. A default value is “not set”.

As described above, the printing apparatus 103 is equipped with the NVMEM 304 (storage unit) that stores setting information indicating predetermined respective settings for setting items which are for use in printing.

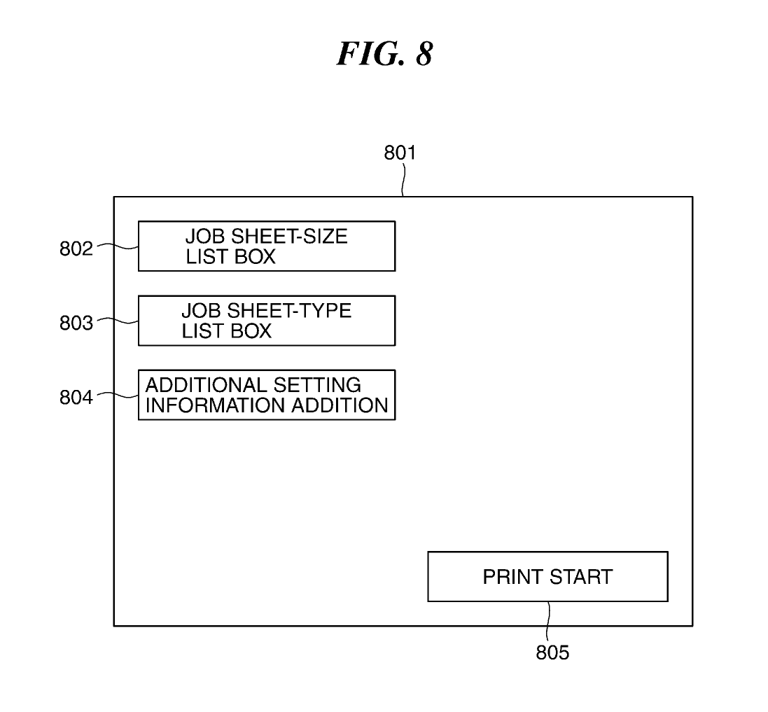

FIG. 8 is a diagram showing an example of a screen of a printer driver 801 displayed on the display section 210 appearing in FIG. 2. In FIG. 8, the printer driver 801 is represented by the screen displayed thereby.

The printer driver 801 is executed by the CPU 201 of the PC 102.

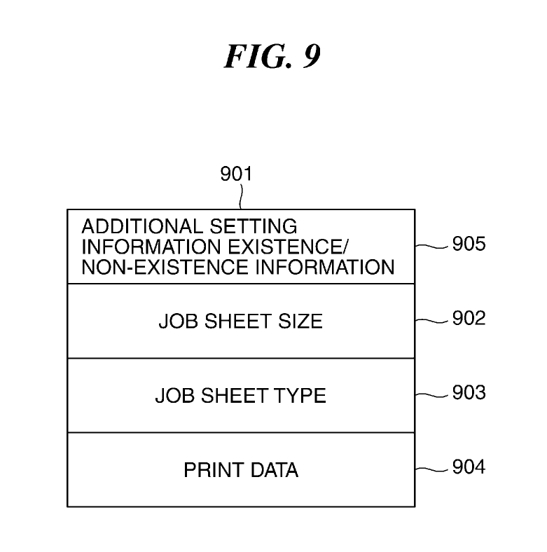

The user 101 can send job information 901 (see FIG. 9) to the server 104 by using the printer driver 801.

The printer driver 801 is connected to the server 104 through the LAN interface 207. When the user 101 installs the printer driver 801 in the PC 102, the printer driver 801 is associated with the server 104.

The printer driver 801 has a job sheet-size list box 802. By selecting an option from the job sheet-size list box 802, the user 101 can designate a job sheet size 902 in the job information 901 shown in FIG. 9. Selectable options (sheet sizes) are A4, A3, B5, letter size, and so forth. If the user 101 does not select any option, a default value of A4 is designated.

The printer driver 801 has a job sheet-type list box 803 as well. By selecting an option from the job sheet-type list box 803, the user 101 can designate a job sheet type 903 in the job information 901. Selectable options (sheet types) are plain paper, thick paper, thin paper, and so forth. If the user 101 does not select any option, a default value of plain paper is designated.

The printer driver 801 has an additional setting information addition button 804 as well. When the user 101 depresses the additional setting information addition button 804, a setting information addition dialog 1001 is displayed. The user 101 can add additional pieces of setting information to the print job by operating the additional setting information addition dialog 1001, described hereinafter. If the user 101 does not select any option from the additional setting information addition dialog 1001, no additional setting information is added to the print job.

The printer driver 801 has a print start button 805 as well. When the user 101 depresses the print start button 805, the printer driver 801 generates a print job. The print job is transmitted to the server 104 through the LAN interface 207.

FIG. 9 is a diagram showing the job information 901 in a case when no additional setting information has been added.

Additional setting information existence/non-existence information 905 stores a value indicating whether additional setting information has been added or not. FIG. 9 shows the case where no additional setting information has been added, and hence a value of 0 is stored.

The job sheet size 902 stores the sheet size designated from the job sheet-size list box 802.

The job sheet type 903 stores the sheet type designated from the job sheet-type list box 803.

Print data 904 is image data designated by the user 101.

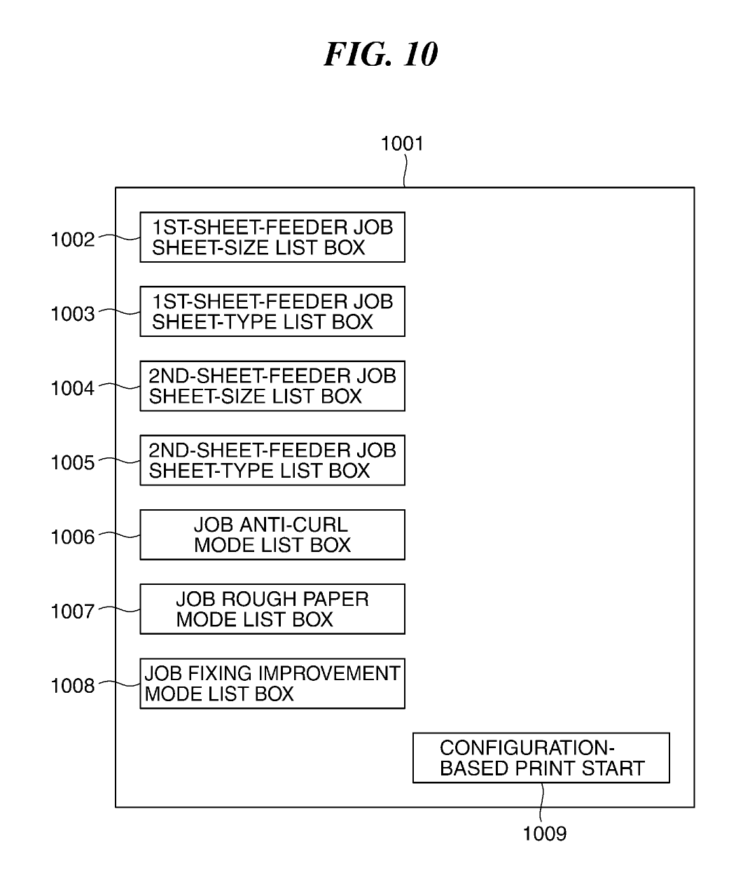

FIG. 10 is a diagram showing the additional setting information addition dialog 1001 displayed on the display section 210 appearing in FIG. 2.

The additional setting information addition dialog 1001 is executed by the CPU 201 of the PC 102.

The user 101 can set job information 1101 as desired, by manipulating the additional setting information addition dialog 1001, using the operating section 206.

By selecting an option from a first-sheet-feeder job sheet-size list box 1002, the user 101 can designate a first-sheet-feeder job sheet size 1102 in the job information 1101. Selectable options (sheet sizes) are A4, A3, B5, letter size, and so forth. If the user 101 does not select any option, a default value of A4 is designated.

By selecting an option from a first-sheet-feeder job sheet-type list box 1003, the user 101 can designate a first-sheet-feeder job sheet type 1103 in the job information 1101. Selectable options (sheet types) are plain paper, thick paper, thin paper, and so forth. If the user 101 does not select any option, a default value of plain paper is designated.

By selecting a second-sheet-feeder job sheet-size list box 1004, the user 101 can designate a second-sheet-feeder job sheet size 1104 in the job information 1101. Selectable options (sheet sizes) are A4, A3, B5, letter size, and so forth. If the user 101 does not select any option, a default value of A4 is designated.

By selecting a second-sheet-feeder job sheet-type list box 1005, the user 101 can designate a second-sheet-feeder job sheet type 1105 in the job information 1101. Selectable options (sheet types) are plain paper, thick paper, thin paper, and so forth. If the user 101 does not select anything, a default value of plain paper is designated.

By selecting an option from a job anti-curl mode list box 1006, the user 101 can designate a job anti-curl mode 1106 in the job information 1101. Selectable options (operation mode values) are “not set”, “level 1”, and “level 2”. If the user 101 does not select any option, a default value of “not set” is designated. Note that if an operation mode value other than “not set” is set in a job rough paper mode list box 1007, a setting in the job anti-curl mode list box 1006 is made invalid.

By selecting an option from a job rough paper mode list box 1007, the user 101 can designate a job rough paper mode 1107 in the job information 1101. Selectable options (operation mode values) are “not set”, “level 1”, and “level 2”. If the user 101 does not select any option, a default value of “not set” is designated. Note that if an operation mode value other than “not set” is set in the job anti-curl mode list box 1006, a setting in the job rough paper mode list box 1007 is made invalid.

By selecting an option from a job fixing improvement mode list box 1008, the user 101 can designate a job fixing improvement mode 1108 in the job information 1101. Selectable options (operation mode values) are “not set”, “level 1”, and “level 2”. If the user 101 does not select any option, a default value of “not set” is designated.

The additional setting information addition dialog 1001 has a configuration-based print start button 1009. If the user 101 depresses the configuration-based print start button 1009, the printer driver 801 generates the job information 1101. The job information 1101 is transmitted to the server 104 through the LAN interface 207.

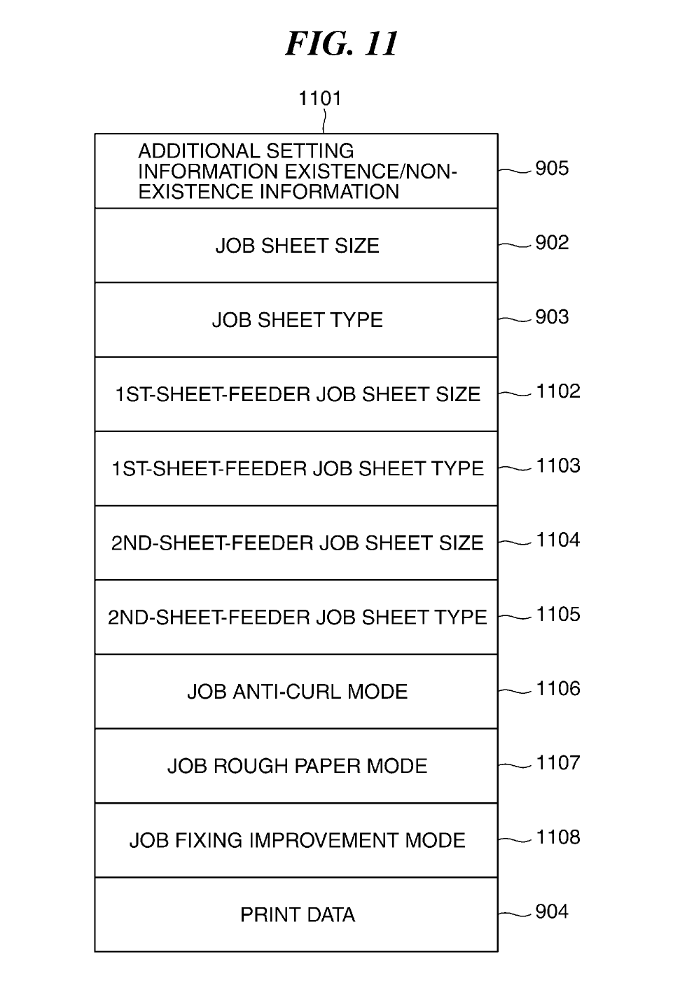

FIG. 11 is a diagram showing the job information 1101 in a case where additional setting information has been added.

The additional setting information existence/non-existence information 905 stores the value indicating whether additional setting information has been added or not. FIG. 11 shows the case where additional setting information has been added, and hence a value of 1 is stored. The job sheet size 902 and the job sheet type 903 are as described hereinabove.

The first-sheet-feeder job sheet size 1102 stores the first-sheet-feeder job sheet size designated from the first-sheet-feeder job sheet-size list box 1002.

The first-sheet-feeder job sheet type 1103 stores the first-sheet-feeder job sheet type designated from the first-sheet-feeder job sheet-type list box 1003.

The second-sheet-feeder job sheet size 1104 stores the second-sheet-feeder job sheet size designated from the second-sheet-feeder job sheet-size list box 1004.

The second-sheet-feeder job sheet type 1105 stores the second-sheet-feeder job sheet type designated from the second-sheet-feeder job sheet-type list box 1005.

The anti-curl mode 1106 stores the operation mode value designated from the job anti-curl mode list box 1006.

The rough paper mode 1107 stores the operation mode value designated from the job rough paper mode list box 1007.

The fixing improvement mode 1108 stores the operation mode value designated from the job fixing improvement mode list box 1008.

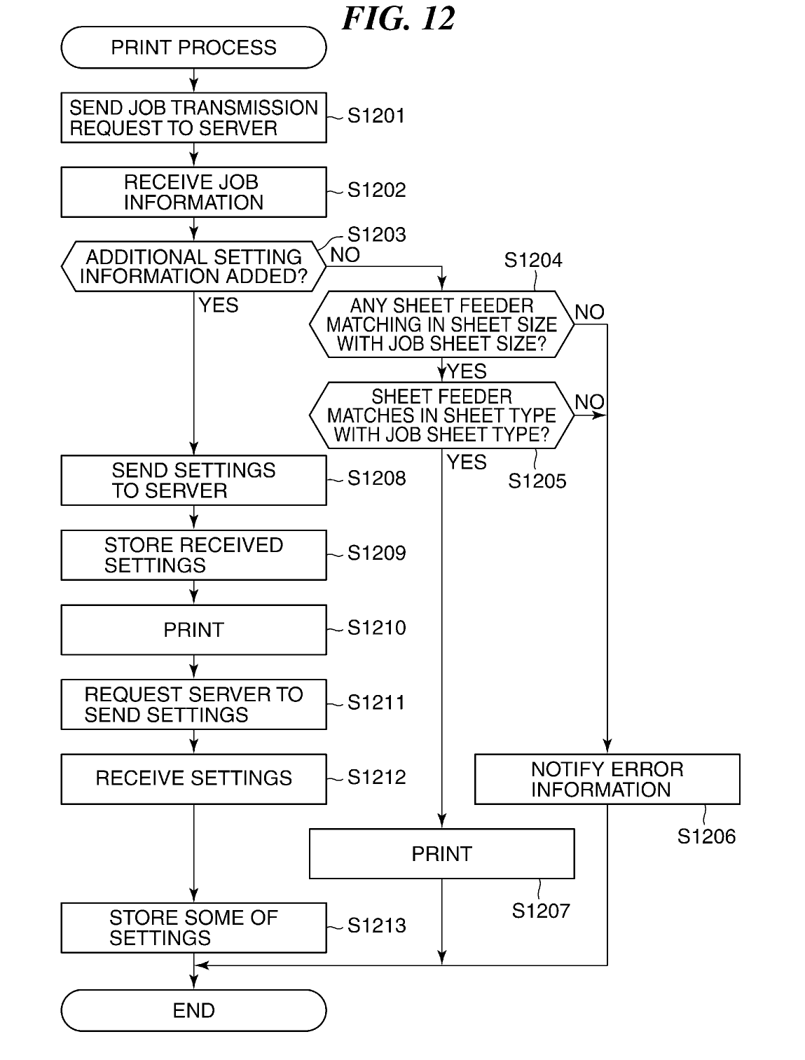

FIG. 12 is a flowchart of a print process executed through execution of a program stored in the flash ROM 302, which is read and loaded into the RAM 303 by the CPU 301.

The print process shown in FIG. 12 is executed by the controller unit 313 of the printing apparatus 103, when the user 101 sends a job transmission request to the server 104 by using the operating section 316 of the printing apparatus 103.

Upon accepting an operation by the user 101 via the operating section 316 for sending a job transmission request to the server 104, the printing apparatus 103 sends the job transmission request to the server 104 via the LAN interface 314 (step S1201).

When the job information 901 or 1101 is transmitted from the server 104, the printing apparatus 103 receives the job information 901 or 1101 (step S1202), and stores the same in the RAM 303. The step S1202 corresponds to a function of a reception unit configured to receive job information including image data to be printed, from the host device (PC 102) (by way of the server 104).

Next, it is determined whether or not additional setting information has been added to the job information 901 or 1101 by referring to the additional setting information existence/non-existence information 905 (step S1203).

If it is determined in the step S1203 that no additional setting information has been added (NO to the step S1203), i.e. if the received job information is the job information 901, it is determined whether or not there is any sheet feeder storing sheets whose sheet size matches the job sheet size 902 in the job information 901 (step S1204). Specifically, the value of the job sheet size 902 is compared with the value of the first-sheet-feeder sheet size 701 and the value of the second-sheet-feeder sheet size 703.

If it is determined in the step S1204 that there is no sheet feeder storing sheets whose sheet size matches the job sheet size 902 (NO to the step S1204), error information is notified to the user interface application 501 via the LAN interface 314 (step S1206), followed by terminating the present process.

On the other hand, if it is determined in the step S1204 that there is a sheet feeder storing sheets whose sheet size matches the job sheet size 902 (YES to the step S1204), it is determined whether or not the job sheet type of the sheets stored in the sheet feeder matches the job sheet type 903 (step S1205). Specifically, the value of the sheet type of the sheet feeder storing sheets the sheet size of which has been determined in the step S1204 to match the sheet size 902 is compared with the job sheet type 903.

If it is determined in the step S1205 that the sheet type of the sheet feeder storing sheets the sheet size of which has been determined to match the sheet size 902 does not match the job sheet type 903 (NO to the step S1205), the above-mentioned step S1206 is executed.

On the other hand, if it is determined in the step S1205 that the sheet type of the sheet feeder storing sheets the sheet size of which has been determined to match the job sheet size 902 matches the job sheet type 903 (YES to the step S1205), printing of the print data 904 is executed using the sheet feeder storing sheets whose sheet type matches the job sheet type 903 (step S1207), followed by terminating the present process.

If it is determined in the step S1203 that additional setting information has been added (YES to the step S1203), i.e. if the received job information is the job information 1101, the settings in the management table 708 stored in the NVMEM 304 are transmitted to the server 104 via the LAN interface 314 (step S1208). The step S1208 corresponds to a function of a hold unit configured to, in a case where received setting information includes setting information configured at the host device (PC 102), temporarily hold setting information stored in the storage unit (NVMEM 304). Note that in the present embodiment, the setting information is transmitted to the server 104, whereby the server 104 is caused to temporarily hold the setting information.

Next, according to the additional setting information added to the job information, various settings are stored in the NVMEM 304 (step S1209). Specifically, the following processes are executed.

First, the value of the first-sheet-feeder job sheet size 1102 is stored in the first-sheet-feeder sheet size 701. The value of the first-sheet-feeder job sheet type 1103 is stored in the first-sheet-feeder sheet type 702. Similarly, the value of the second-sheet-feeder job sheet size 1104 is stored in the second-sheet-feeder sheet size 703. The value of the second-sheet-feeder job sheet type 1105 is stored in the second-sheet-feeder sheet type 704.

Further, the value of the job anti-curl mode 1106 is stored in the anti-curl mode 705. The value of the job rough paper mode 1107 is stored in the rough paper mode 706. The value of the job fixing improvement mode 1108 is stored in the fixing improvement mode 707.

Next, the printing apparatus 103 prints the print data 904 (step S1210). The above-mentioned step S1209 corresponds to a function of a storing unit configured to store the setting information configured at the host device (PC 102) in the storage unit (NVMEM 304), and the step S1210 corresponds to a printing unit configured to print the image data according to the setting information stored by the storing unit.

Then, after execution of printing in the step S1210, the printing apparatus 103 requests, in a step S1211, the server 104 to transmit the settings in the management table 708 which have been transmitted to the server 104 in the step S1208 for being held therein.

The printing apparatus 103 receives the settings in the management table 708 from the server 104 (step S1212). Thus, the printing apparatus 103 stores some of the settings, received from the server 104, as settings in the management table 708 in the NVMEM 304 (step S1213), followed by terminating the present process. Thus, after printing, the printing apparatus 103 stores the settings of some of the configuration items indicated by the setting information being held, in the NVMEM 304.

Specifically, the printing apparatus 103 stores the settings of the anti-curl mode 705, the rough paper mode 706, and the fixing improvement mode 707 in the NVMEM 304.

Although the settings in the management table 708 are transmitted to the server 104 in the print process (step S1208), they may be held by being stored in the RAM 303 which is a memory device provided in the printing apparatus 103. In other words, the present print process can be executed without using the server 104. In this case, although in the present print process, the settings in the management table 708 are received from the server 104 (steps S1211 and 1212), they may be read out from the RAM 303.

According to the print process shown in FIG. 12, in a case where job information received by the printing apparatus 103 includes setting information configured at the PC 102, the server 104 is caused to temporarily hold the setting information stored in the NVMEM 304 of the printing apparatus 103, while the printing apparatus 103 is caused to store the setting information configured at the PC 102, in the NVMEM 304. Then, the printing apparatus 103 prints the image data according to the setting information configured at the PC 102, and hence, when the printing apparatus executes the printing, even if the print settings of a print job are different from the settings of the printing apparatus, the user need no change the print settings at the PC 102. As a result, it is possible to provide a printing apparatus incapable of changing print settings when executing printing, which is improved in user-friendliness when the print settings are different from the settings of the printing apparatus.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2011-193132 filed Sep. 5, 2011, which is hereby incorporated by reference herein in its entirety.

What is claimed is:

1. A printing apparatus including a storage unit that stores setting information indicating predetermined respective settings for setting items which are for use in printing, comprising:
a reception unit configured to receive job information including image data to be printed, from a host device;
a hold unit configured to, in a case where the job information which is received by said reception unit includes setting information configured at the host device, temporarily hold the setting information stored in the storage unit;
a storing unit configured to store the setting information configured at the host device in the storage unit; and
a printing unit configured to print the image data according to the setting information stored by said storing unit.

2. The printing apparatus according to claim 1, wherein after printing is executed by said printing unit, setting information held by said hold unit are stored in the storage unit.

3. The printing apparatus according to claim 1, wherein said hold unit causes the host device to temporarily hold the setting information stored in the storage unit, by transmitting the setting information to the host device, or causes a memory device provided in the printing apparatus to temporarily hold the setting information.

4. The printing apparatus according to claim 1, wherein said hold unit causes a server which is connectable to the printing apparatus to temporarily hold the setting information stored in the storage unit, by transmitting the setting information to the server.

5. The printing apparatus according to claim 1, wherein the setting information configured at the host device includes information indicative of a setting temperature for a fixing device.

6. The printing apparatus according to claim 1, wherein the setting information configured at the host device includes at least one of information indicative a setting temperature for a fixing device and information indicative of an amount of toner to be fixed to a sheet.

7. The printing apparatus according to claim 1, further comprising a determination unit configured to determine whether the job information which is received by said reception unit includes the setting information configured at the host device.

8. The printing apparatus according to claim 7, wherein the job information which is received by said reception unit includes information indicating whether or not the job information includes the setting information, and
wherein said determination unit determines, based on the information, whether the job information which is received by said reception unit includes the setting information.

9. A method of controlling a printing apparatus including a storage unit that stores setting information indicating predetermined respective settings for setting items which are for use in printing, comprising:
receiving job information including image data to be printed, from a host device;
temporarily holding, in a case where the received job information includes setting information configured at the host device, the setting information stored in the storage unit;
storing the setting information configured at the host device in the storage unit; and
printing the image data according to the setting information stored by said storing.

10. A non-transitory computer-readable storage medium storing a computer-executable program for causing a computer to execute a method of controlling a printing apparatus including a storage unit that stores setting information indicating predetermined respective settings for setting items which are for use in printing,
wherein the method comprises:
receiving job information including image data to be printed, from a host device;
temporarily holding, in a case where the received job information includes setting information configured at the host device, the setting information stored in the storage unit;
storing the setting information configured at the host device in the storage unit; and
printing the image data according to the setting information stored by said storing.
